(19) United States
(12) Patent Application Publication
(10) Pub. No.: US 2017/0184301 A1
(43) Pub. Date: Jun. 29, 2017

(54) System for Prevention of Computer Vision Syndrome

(71) Applicant: Catholic Memorial High School of Waukesha, Inc., Waukesha, WI (US)

(72) Inventors: Samuel R Aspinwall, Brookfield, WI (US); Jared C. Bluma, Waukesha, WI (US); Max D. Mutza, Waukesha, WI (US)

(21) Appl. No.: 15/393,979

(22) Filed: Dec. 29, 2016

Related U.S. Application Data
(60) Provisional application No. 62/272,219, filed on Dec. 29, 2015.

(51) Int. Cl. F21V 33/00; F21V 21/08; F21V 23/04; F21V 21/088

(52) U.S. Cl. CPC F21V 33/0052; F21V 21/088; F21V 21/0808; F21V 23/0407; F21Y 2115/10

(57) ABSTRACT

When a person uses a computer, the graphic display of the computer screen causes a user's eye blink rate to be reduced by an average of sixty-six percent. This reduction in blinking can cause a variety of eye ailments, such as eye strain that results from lack of adequate blinking. This system is a light display system for compelling a computer user to blink their eyes. In one embodiment, the system includes a computer screen, a light source associated with a controller configured to execute a program to activate and deactivate the light source, wherein the light source turns the light on and off when the light source is activated, and deactivated. The systems and methods provide advantages in that a computer user will involuntarily blink as the light source is activated, which will increase the overall blink rate of the computer user's eyes, and reduce eyestrain therefrom.

### CROSS REFERENCE TO RELATED APPLICATION

This application claims the benefit of U.S. Provisional Application 62/272,219 filed Dec. 29, 2015 and is hereby incorporated by reference.

### BACKGROUND OF THE INVENTION

### 1. Field of the Invention

The present invention relates in general to the field of optometry. More particularly, the present invention relates to eye and vision problems developed during prolonged computer or electronic device use. Specifically, a preferred embodiment of the present invention relates to a light source fastened to an electronic screen such as a computer monitor that emits light at random intervals, causing the computer operator to involuntarily blink, which is used to increase blink rate and reduce astheniopia (eyestrain). Alternatively, the light source may be attached to a television screen, a computer tablet, a laptop computer, or any other digital or electronic screen.

According to some studies, Computer Vision Syndrome (CVS) may affect as many as 140 million Americans, or 70% of employed people in the United States. CVS developed at the workplace causes blurred vision, headaches, and eye strain, which can distract you from work and reduce productivity. CVS is a generalized term for a group of eye and vision-related problems that develop from prolonged viewing of digital screens. The phrase digital screen is used because CVS is not just limited to computer use. The symptoms of CVS can also develop from the use of screens on cell phones, reading devices, gaming devices, and tablets as well. This condition is chronicled by the American Optometric Association and on the American Optometric Association website article: http://www.aoa.org/patients-and-public/caring-for-your-vision/protecting-your-vision/computer-vision-syndrome?sso=y.

People that spend more than two continuous hours on digital screens daily will be at the greatest risk of experiencing symptoms of CVS. It is estimated that the average American adult spends 45% of their day looking at some form of a digital screen. More than ninety percent of adults in the United States of America report to using digital devices for longer than two hours a day.

The group most susceptible to CVS currently is office workers who use computers throughout their workday, and oftentimes watch television or go on their personal computer after their work shift. Surprisingly, nearly one in four children born between 1997 and 2014 use a digital device for more than three hours a day. These children have still currently-developing eyes, and this over-exposure puts them at an even more serious risk of CVS. For example, when a person is using a computer, their blinking rate is reduced by an average of sixty-six percent. The extended duration of digital screen use strains the eye and causes overuse and fatigue of the orbicularis oculi, which is the primary ocular muscle related to squinting and blinking. When the blink rate is reduced and the eye is fatigued, symptoms of CVS begin to manifest.

Symptoms of CVS include blurred vision, eye fatigue, dry eyes, irritated eyes, headache, neck aches, back aches, and double vision. The presence of any number of these factors can slow productivity, and cause distraction from tasks.

Presently, there are only a few products designed to attempt to address CVS, but none of the attempted solutions address blinking as an issue. Also, most are glasses which only address the problem of glare, and they do not serve any people affected by CVS who do not wear glasses.

What is needed therefore is a device, method, or system that provokes a computer user to blink more often, so as to combat the onset of CVS.

### BRIEF DESCRIPTION OF THE INVENTION

By way of summary, the present invention is directed to a light display system for a computer monitor or other electronic device. An effect of the present invention is to increase the blink rate of computer users, so as to reduce eye strain, and the CVS symptoms that results in fatigue from a lack of blinking. The light display system preferably includes at least one light source, and a controller configured to execute a program stored in a non-transitory computer-readable-medium, which is set to activate and deactivate the light source over a pre-determined time interval.

In accordance with a first aspect of the invention, these objects are achieved by providing an apparatus comprising at least one light source, connected to a controller configured to execute a program. The program is designed to activate and deactivate the light source, so as to turn on and off the light. The intended effect is to flash the light at either random or pre-determined intervals towards the computer user, so as to cause the user to involuntarily blink their eyes. The light source may be a light-emitting diode (LED) bulb, but it is not intended to be limited as such. Other alternative light source methods could be a compact fluorescent (CFL), incandescent, fluorescent, halogen, lumen, or other light emitting source without separating from the spirit of the concept.

In one embodiment, the system is embedded into the perimeter of a computer screen. The connection method is inside the monitor, and the system is run off the power of the central processing unit (CPU).

Another embodiment has the light source connected to the central processing unit of a computer, which utilizes a program, typically either hardware or software, which provides similar benefits of the microcontroller/microprocessor. That is, the program will also turn on and off the light source, so as to emit the light at random intervals. As such, there is no need for add-on components in this embodiment.

In an alternative embodiment of the invention, the light source, or plurality of, is attached to a frame. The frame is designed to fit over an electronic screen such as a computer monitor, as to allow the light system to be operated on a person's current computer monitor. The light source(s) is connected to a controller, such as one in the CPU itself, or in a portable microcontroller/microprocessor. The controller will be designed, similar to alternate embodiments, to turn on and off the light source at random or fixed intervals. The frame may be substantially rectangular or generally square in shape to cover the shape of a traditional monitor or screen such as a television, but may also be constructed in different shapes. The frame may possibly be constructed of a polymer, or alternatively may be constructed of wood, metal, or any other material.

In another alternative embodiment of the invention, there is a light source, or plurality thereof, built into the perimeter of a computer screen monitor or frame. The light source will thus be connected internally, and be adapted built-in internally in production of computer monitors. The light source will be connected to a controller as previous embodiments were, and to the generally same effect.

In another embodiment, which includes, but is not limited to, a kit, is utilized where the parts necessary for the system to operate are compiled. Using this kit, a light source is attached to an existing monitor or electronic device such as a television, mobile device, or handheld device such as a personal computer tablet. The light source may also be connected to a desktop computer, a laptop computer, or even a microcontroller (or microprocessor), which utilizes a coded program that allows for the light to emit at fixed or random intervals. This ability gives the effect of retrofitting an existing monitor to have the light flasher capabilities.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWING(S)

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 illustrates a view of a traditional electronic screen such as a computer monitor 5, according to the present invention. FIG. 1 also shows and highlights the outer perimeter of an electronic screen such as the perimeter of a computer monitor 1;

FIG. 2 illustrates a view of a traditional desktop computer monitor, and computer wires;

FIG. 3 illustrates a view of a traditional laptop computer, and computer wires;

FIG. 4 illustrates a view of a portable microcontroller/microprocessor and computer wires;

FIG. 5 illustrates a view of the frame of one particular embodiment of the present invention, and a demonstration of a possible arrangement and placement of light(s) on the frame; and

FIG. 6 illustrates the method of retrofitting an existing computer monitor using a kit comprising the required components of the present invention.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DETAILED DESCRIPTION OF THE PREFERRED EMBODIMENTS

The various features and advantageous details of the subject matter disclosed herein are explained more fully with reference to the non-limiting embodiments described in detail in the following description.

The current invention is an apparatus that goes around the frame of a computer monitor or other electronic device with lights built into the edges of the screen. These lights flash randomly every few seconds or at fixed intervals, catching your attention and making you blink.

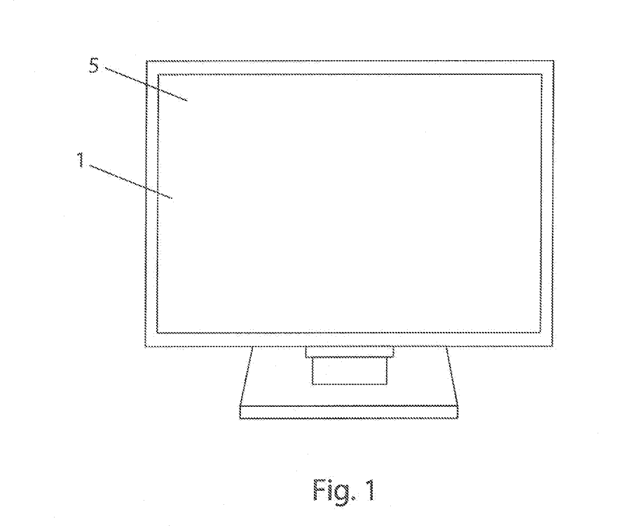

Referring more specifically to FIG. 1, a conventional computer monitor and screen 5 are shown. The present invention includes a light(s) source 25 that may be attached around the perimeter of the screen 5, on the computer monitor perimeter 1. This attachment to the computer monitor perimeter 1 may be provided through various methods, such as through an attachment device, e.g., a clamp, or an adhesive method, such as with an adhesive strip. Alternatively, the present invention light(s) source 25 may be installed inside the computer monitor perimeter 1. Additionally, the present invention light(s) source 25 may be installed on a removable frame unit 30, so as to be moved between different computer monitors 5, or laptop computers 15.

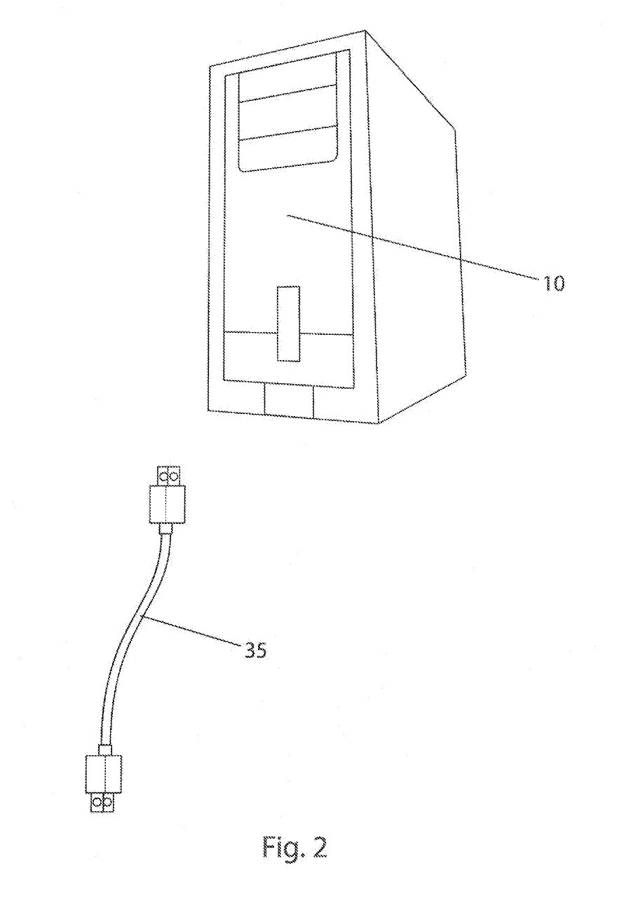

Referring now to FIG. 2, an embodiment of the present invention utilizing a traditional desktop computer tower 10 is shown. The system may be connected to the desktop computer tower 10 to provide power to the system. The connection method may or may not use wires 35 as a means to connect the light(s) source 25 to the desktop computer tower 10.

Although the preferred embodiment shown in FIG. 2 includes the desktop computer tower 10, it is within the level of ordinary skill in the art after having knowledge of the invention disclosed herein to also implement this present invention on a laptop computer 15 or may utilize a portable microcontroller 20 or alternately may utilize a portable microprocessor 20 to provide power to the light(s) source 25.

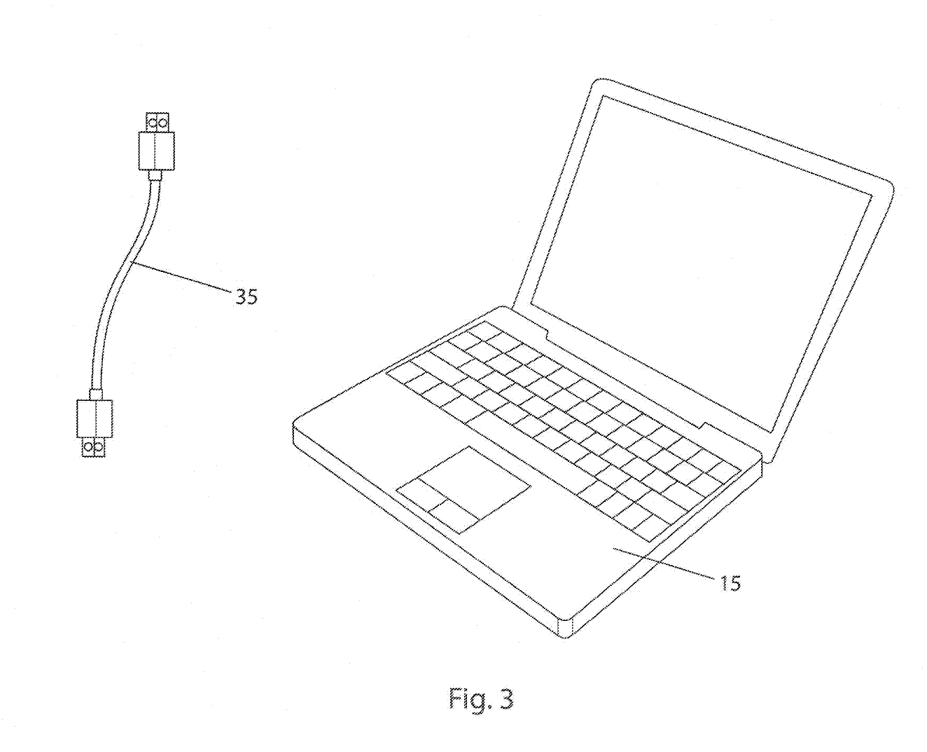

Referring now to FIG. 3, an embodiment utilizing a traditional laptop computer 15 is shown. The system may be connected to the laptop computer 15 to provide power to the system. The connection method may or may not use wires 35 as a means to connect the light(s) source 25 to the laptop computer 15.

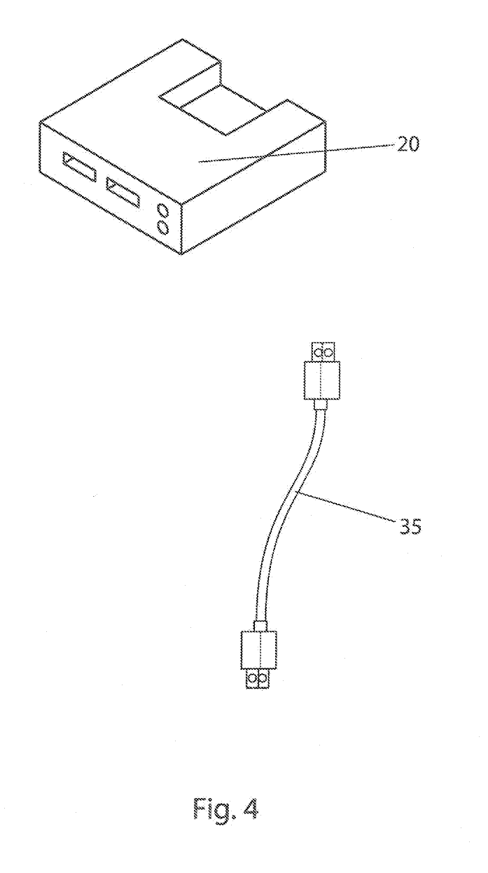

Referring now to FIG. 4, an embodiment utilizing a traditional portable microcontroller (or microprocessor) 20 is shown. The system may be connected to the traditional portable microcontroller (or microprocessor) 20 to provide power to the system. The connection method may or may not use wires 35 as a means to connect the light(s) source 25 to the traditional portable microcontroller (or microprocessor) 20.

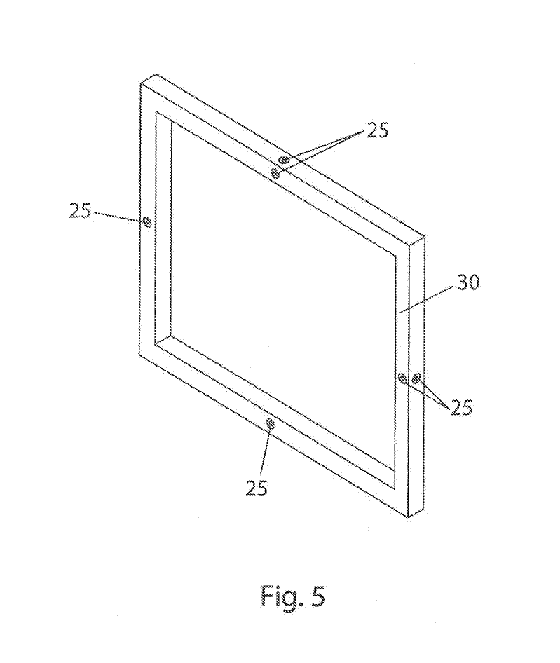

Referring now to FIG. 5, an embodiment of the invention is shown, wherein a frame 30 is constructed, and the light(s) source 25 of the system are installed therein. The frame 30 may be constructed of any material, such as wood, metal, a polymer, or the like. The frame 30 may be built to any size specifications, and preferably is built with size specifications similar to that of the current computer monitor perimeter 1. The frame 30 is set on top of, and resting on, the computer monitor perimeter 1.

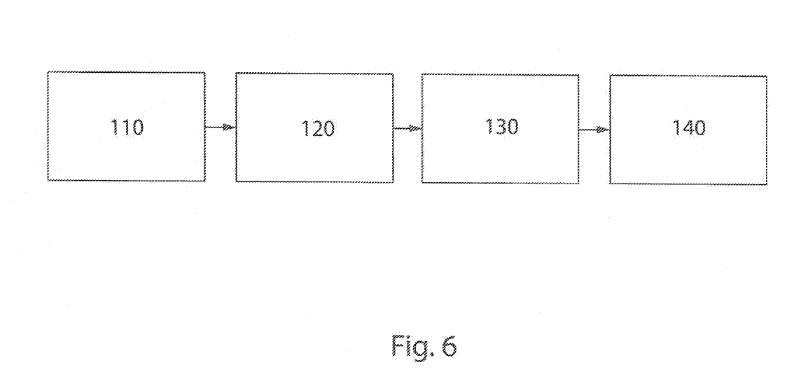

Referring now to FIG. 6, an embodiment of the invention is shown, wherein a kit is used to retrofit an existing computer monitor 5. The first step 110, is where a user is in possession of the retrofit kit that is comprised of an attachment means, possibly a clamp or an adhesive method, a connection method such as computer wires, and a light source 25. The second step 120 is where the user removes said parts from the kit in order to access the parts. The third step 130 is where the user using the attachment means in order to affix the light source 25 to the outside perimeter 1 of the computer monitor 5. The fourth step, 140 is where the user uses the connection means, such as wires 35, to connect the light(s) source 25 to the chosen power source of either a desktop computer tower 10, a laptop computer 15, or a portable microcontroller/microprocessor 20.

All the disclosed embodiments are useful in conjunction with the present invention, such as they are used for the purpose of flashing a light at a computer user's eyes so as to compel an involuntary eye blink, or the like. There are virtually innumerable uses for the present invention, such as for on a mobile device, a television screen or the like and all of which need not be detailed here. All the disclosed embodiments can be practiced without undue experimentation.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

Although an LED is preferred for the light source, any material could be used in its place. In addition, the individual components need not be fabricated from the disclosed materials, but could be fabricated from virtually any suitable materials.

Moreover, the individual components need not be formed in the disclosed shapes, or assembled in the disclosed configuration, but could be provided in virtually any shape, and assembled in virtually any configuration, and it will be manifest that the system of the present invention may be integrated into the apparatus with which it is associated. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

We claim:

1. A light display system for compelling a user to blink their eyes, the system comprising:
an electronic screen;
a light source;
a controller configured to execute a program stored in a non-transitory computer-readable-medium, to activate and deactivate the light source;
wherein the light source is located near an outside edge of the electronic screen; and
wherein activating the light source turns the light ON and deactivating the light source turns the light OFF.

2. The system of claim 1, wherein a sequence of the interval of activation and deactivation of the light source is randomized.

3. The system of claim 1, wherein the pre-determined interval to activate and deactivate the light source is a fixed time duration.

4. The system of claim 2, wherein the light source is a light-emitting diode.

5. The system of claim 3, wherein the light source is a plurality of light-emitting diodes in close proximity to the graphic display.

6. The system of claim 2, wherein the light source is embedded in the perimeter of the electronic screen.

7. The system of claim 2, wherein the light source is attached to a removable and reusable frame.

8. The system of claim 3, wherein the light source is embedded in the perimeter of the electronic screen.

9. The system of claim 3 wherein the light source is attached to a removable and reusable frame.

10. The removable and reusable frame of claim 7, wherein the frame is rectangular in shape.

11. The removable and reusable frame of claim 9, wherein the frame is rectangular in shape.

12. The removable and reusable frame of claim 10, wherein the frame is composed of a material selected from the group of polymer, wood, and metal.

13. The removable and reusable frame of claim 11, wherein the frame is composed of a material selected from the group of polymer, wood, and metal.

14. The system of claim 12 wherein the electronic screen is a computer monitor.

15. The system of claim 12 wherein the electronic screen is part of a portable computer.

16. A retrofit electronic screen kit comprising:
a light source;
an electronic screen;
a means for attaching the light source on an existing electronic monitor; and
a controller configured to execute a program stored in a non-transitory computer-readable medium, to activate and deactivate the light source;
wherein the light source is located near an outside edge of the electronic screen; and
wherein activating the light source turns the light ON and deactivating the light source turns the light OFF.

17. The kit of claim 16, wherein the means for attaching the light source is at least one clamp attached around the perimeter of an electronic screen.

18. The kit of claim 16, wherein the means for attaching the light source is at least one fastener affixed around the perimeter of an electronic screen.

19. The kit of claim 16, wherein the means for attaching the light source is an adhesive unit, such as an adhesive strip or adhesive units/strips, connected to the light source, which attach near an outside edge of an electronic screen.

20. A method of retrofitting an existing electronic screen with the kit of claim 16, which comprises:
providing a kit which includes an attachment device, at least one light, and a connection method;
removing the parts from the kit for use;
using the affixing means to attach the light to the perimeter of the electronic screen; and
connecting the light source to a power source.
